(19) United States
(12) Patent Application Publication
(10) Pub. No.: US 2006/0213456 A1
(43) Pub. Date: Sep. 28, 2006

(54) Animal feces collecting device

(76) Inventor: Laura Paquette, Lachenaie (CA)

Correspondence Address: LESPERANCE & MARTINEAU, 1440 WEST, STE-CATHERINE ROOM 700, MONTREAL, QC, H3G1R8, CA

(21) Appl. No.: 11/085,120

(22) Filed: Mar. 22, 2005

(51) Int. Cl. A01K 23/00

(52) U.S. Cl. 119/868

(57) ABSTRACT

The animal feces collecting device comprises a harness for releasably attaching the collecting device to an animal, at least one arm defining a proximal end pivotally attached to the harness and a distal free end opposite the proximal end, a feces collecting unit carried by the arm at the distal end thereof, and an attachment member carried by the harness. The arm is pivotable between an operative position in which the arm clears the harness and is disengaged from the attachment member for positioning the arm distal end and the feces collecting unit adjacent to the animal's anus, and a stored position in which the arm is pivoted back against the attachment member to attach the arm to the attachment member and for positioning the arm distal end spacedly away from the animal's anus.

### FIELD OF THE INVENTION

The invention relates to an animal feces collecting device, and more particularly to a portable feces collecting device for animals.

### BACKGROUND OF THE INVENTION

It is known to provide feces collecting devices for dogs, that comprise a harness to be installed on the dog's rear body portion. The harness carries a pouch to collect the animal's feces when he defecates. The pouch is carried against the dog's buttocks by the harness so as to form a sealed enclosure around the dog's anus, in which the feces will be collected. However, such prior art devices are complicated to remove from the dog, and consequently the dog will often remain equipped with the harness and pouch during his entire walk outside, resulting in the feces remaining within the pouch, often applied directly against the dog's buttocks. A problem will often arise when the dog sits on the ground, since the underlying feces-carrying pouch will then be squeezed under the dog's weight, and the dog may then consequently sit in his feces, or the latter may spill outside of the pouch. This is of course undesirable.

### SUMMARY OF THE INVENTION

The present invention relates to a n animal feces collecting device comprising:

a harness for releasably attaching said collecting device to an animal;

at least one arm defining a proximal end pivotally attached to said harness and a distal free end opposite said proximal end;

a feces collecting unit carried by said arm at said distal end thereof, and

an attachment member carried by said harness;

wherein said arm is pivotable between an operative position in which said arm clears said harness and is disengaged from said attachment member for positioning said arm distal end and said feces collecting unit adjacent to the animal's anus, and a stored position in which said arm is pivoted back against said attachment member to attach said arm to said attachment member and for positioning said arm distal end spacedly away from the animal's anus.

In one embodiment, said animal feces collecting device further comprises a second arm defining a proximal end pivotally attached to said harness and a distal fee end opposite said proximal end and carrying said feces collecting unit in combination with said first arm.

In one embodiment, said feces collecting unit comprises a support member integrally carried by said at least one arm and by said second arm, and a feces receptacle removably engageable in said support.

In one embodiment, said support member is a support ring carried by said at least one arm and by said second arm, with said receptacle comprising an annular rim that is at least semi-rigid and that is sized and shaped to rest on said support ring, and a bag mounted to said annular rim.

In one embodiment, said annular rim can yieldingly deform to close a top mouth portion of said receptacle over said bag.

In one embodiment, said animal feces collecting device further comprises a feces container carried by said harness and sized to receive said receptacle therein.

In one embodiment, said at least one arm and said second arm are telescopic.

In one embodiment, said harness includes a doll body destined to rest on the animal's back and straps for attaching said doll body to the animal's torso, with said feces container representing the head of the doll and being attached to said doll body.

In one embodiment, said harness further comprises a pair of legs that are attached to said doll body and that hang therefrom, for extending along the flanks of the animal's torso when said harness is worn by the animal.

In one embodiment, said pair of legs have an intrinsic spring-back effect that biases them towards the animal's torso to stabilize said harness on the animal's back.

### DESCRIPTION OF THE DRAWINGS

In the annexed drawings:

FIG. 1 is a perspective view of the feces collecting device according to the present invention;

FIG. 2 is a perspective view of the feces collecting device of FIG. 1, operatively installed on a dog that is positioned to defecate;

FIG. 3 is similar to FIG. 1, but with the feces receptacle being removed from its support ring and being manipulated to insert it into the feces container of the feces collecting device;

FIG. 4 is a side elevation of the feces collecting device of FIG. 1, suggesting with dotted lines and arrows the movement of the feces collecting unit support arms from their operative position towards their stored position; and

FIG. 5 is a perspective view of the feces collecting device of FIG. 1, operatively installed on a dog, with the feces collecting unit support arms being in their stored position.

### DETAILED DESCRIPTION OF THE EMBODIMENTS

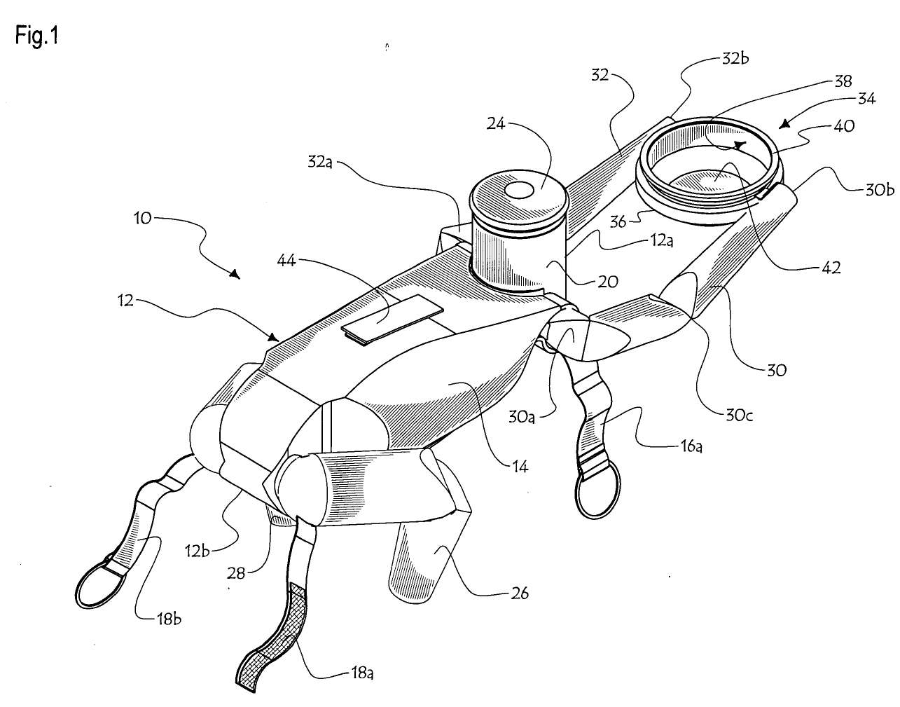

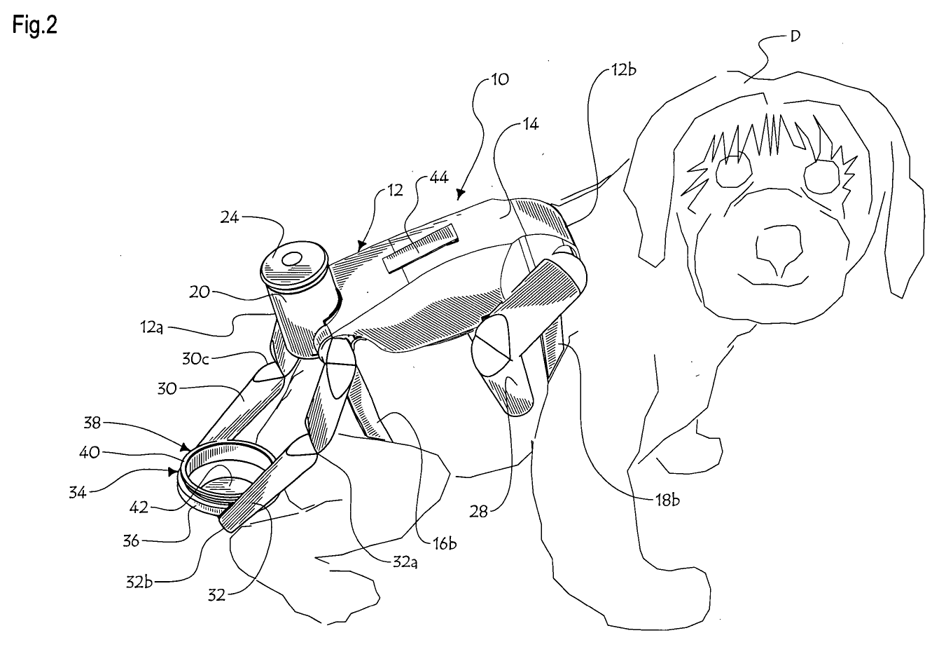

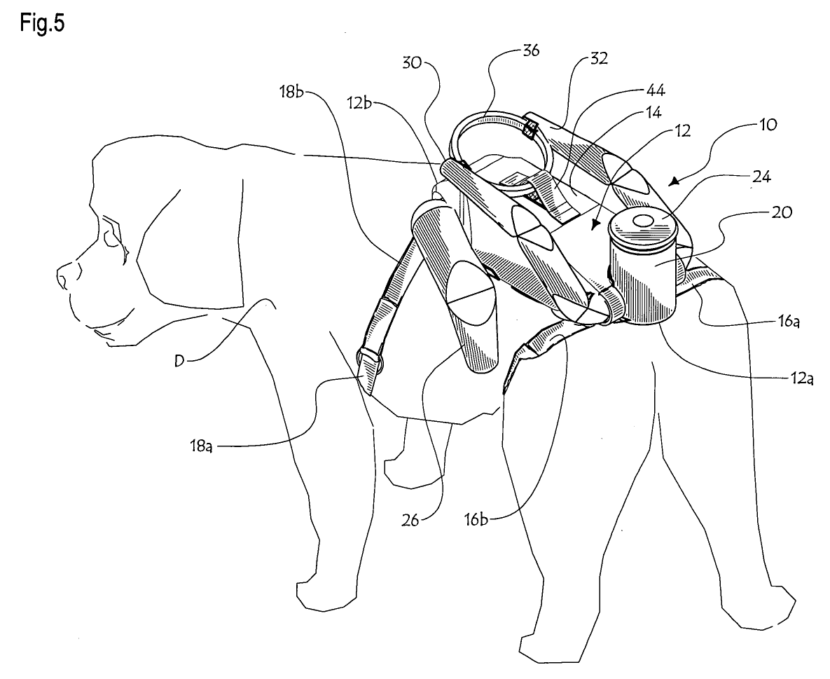

FIGS. 1-5 show a an animal feces collecting device 10 according to the present invention. Feces collecting device 10 comprises a harness 12 for releasably attaching collecting device 10 to an animal such as a dog D as shown in FIGS. 2 and 5. Harness 12 defines a rear end 12a destined to be located over the dog's buttocks, and a front end 12b opposite front end 12a and destined to be located nearer the dog's head. Harness 12 is in the form of a doll body 14 destined to rest on the dog's back, and is equipped with two pairs of cooperating straps 16a, 16b and 18a, 18b that are used to attach the doll body 14 to the animal's torso as shown in FIGS. 2 and 5.

Feces collecting device 10 also comprises a feces container 20 representing the head of the doll that forms the harness, with container 20 being attached to doll body 14 and upwardly projecting therefrom. Container 20 is of course hollow, and includes a top mouth opening 22 closable with a cover 24.

Doll body 14 is equipped with a pair of legs 26, 28 that can be purely decorative, or that can alternately further have a stabilizing role in that they engage the flanks of the dog's torso, and consequently if they are provided with some intrinsic resiliency and a spring-back effect that slightly forces the legs towards the dog's torso, they can contribute to prevent body 14 from tilting to one side or the other.

Feces collecting device 10 further comprises at least one arm, and more specifically first and second arms 30, 32 that define a proximal end 30a, 32a pivotally attached to harness 12, and more particularly to body 14, and a distal free end 30b, 32b opposite their proximal ends 30a, 32a. Arms 30, 32 are further articulated at an elbow 30c, 32c. Both the pivotal attachment 30a, 32a to body 14 and the elbow 30c, 32c of each arm 30, 32 can be made for example by means of a flexible fabric link between rigid portions of arms 30, 32 that allow a free pivotal movement of the respectively interlinked portions, or alternately with suitable hinges or any other suitable pivotal link.

A feces collecting unit 34 is carried by arms 30, 32 at their distal ends 30b, 32b. Collecting unit 34 comprises a support member in the form of a support ring 36 carried by and fixed to first and second arms 30, 32 at their distal ends 30b, 32b. Collecting unit also comprises a feces receptacle 38 removably engageable in support ring 36. Feces receptacle 38 in turn comprises an annular rim 40 that is at least semi-rigid, and a bag 42 mounted to rim 40. Annular rim 40 is destined to rest on support ring 36, with bag 42 loosely extending through ring 36.

An attachment member 44 in the form of a strap is carried on top of body 14.

In use, feces collecting device 10 is installed on an animal such as dog D with rear end 12a of harness 12 aligned over the buttocks of the dog, and with front end 12b of harness 12 located nearer the head of the dog on the dog's back. Depending on the size and shape of the dog, and on the particular configuration of feces collecting device 10, the front end 12b of harness 12 may be located near the dog's shoulders as shown in FIGS. 2 and 5, or nearer or further away from his head.

Once harness 12 rests on top of the dog's back, strap 16a can be attached to strap 16b and strap 18a to strap 18b under the dog's torso, to secure feces collecting device 10 to the dog's back. Rear legs 26, 28 will hang along the sides of the dog's torso, while arms 30, 32 will be positioned to extend rearwardly around the dog's buttocks, so that collecting unit 34 will become positioned immediately under the dog's anus. More particularly, it is envisioned to provide arms 30, 32 of adjustable length that may be telescopic for example, or alternately to have a feces collecting device 10 adapted for use on a dog of a generally precise size and shape. Thus, arms 30, 32 will extend rearwardly around the dog's buttocks, and with the calibrated length of arms 30, 32 and with both extremities 30b, 32b being attached to support ring 36, the arms will come to be slightly tensioned in such a way as to position collecting unit 34 properly adjacent to and under the dog's anus.

When the dog defecates, as suggested in FIG. 2, his feces will naturally fall into collecting unit 34, and more particularly into bag 42 of feces receptacle 38. Feces receptacle 38 is not destined to receive the dog's urine. The dog may indeed urinate freely directly on the ground while wearing feces collecting unit 10, although it could be envisioned to provide an alternate embodiment of the invention wherein the feces collecting unit could also collect urine with only minor modifications to the invention as it is presently illustrated.

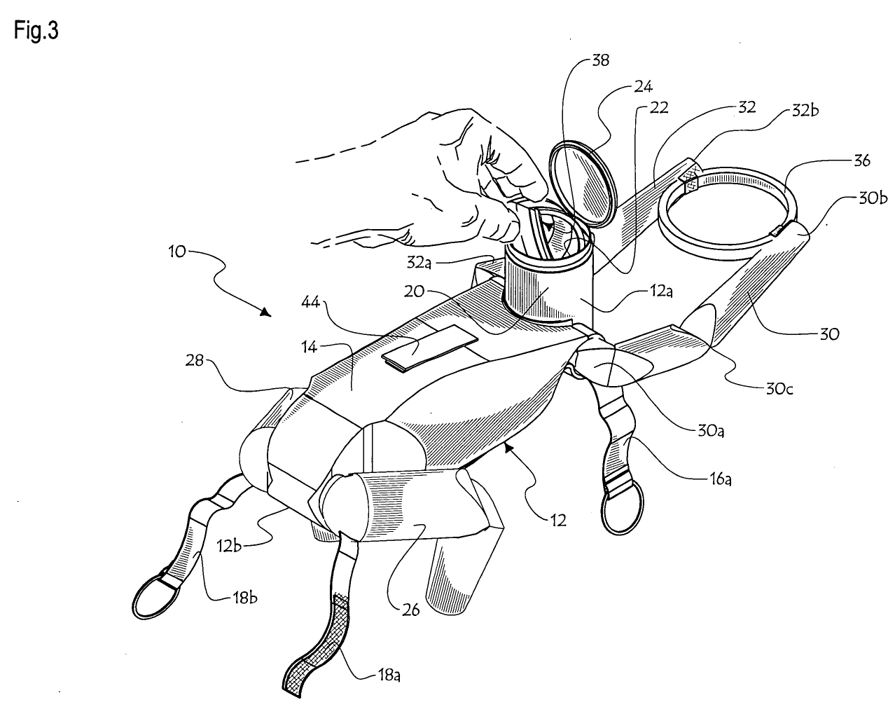

Once the dog is done defecating, it is possible to manually remove feces receptacle 38 containing the feces, to dispose of it in a suitable way. According to the invention, there is provided one convenient manner to dispose of feces receptacle 38, namely by folding it and inserting it into feces container 20 as shows in FIG. 3. More particularly, semi-rigid annular rim 40 can yieldingly deform to close a top mouth portion of receptacle 38 over bag 42, thereby enclosing the feces. Folding feces receptacle 38 beforehand is of course desirable to ensure that all feces will remain within receptacle 38. Afterwards, the cover 24 of container 20 may be opened, receptacle 38 inserted into container 20, and cover 24 closed. Container 24 may be emptied for example once the dog's walk outside is over.

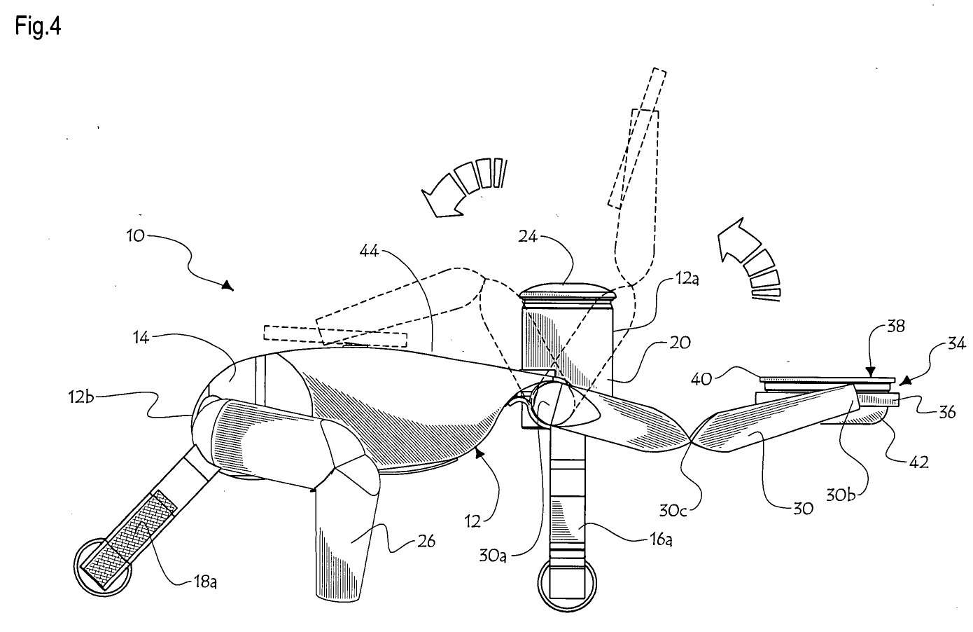

Once the dog has defecated and feces receptacle has been disposed of, for example by storing it in container 20, it is possible to put a new receptacle 38 in support ring 36. Alternately, as suggested in FIGS. 4 and 5, it is possible to pivot arms 30, 32 from their operative position in which they extend rearwardly and clear harness 12 for positioning collecting unit 34 adjacent to the animal's anus to collect feces as described hereinabove, to a stored position in which arms 30, 32 are pivoted back against attachment member 44 to attach arms 30, 32 to attachment member 44. More particularly, in this stored position of arms 30, 32, they are attached to attachment member 44 by the latter having one of its straps engaging support ring 36, as shown in FIG. 5. In this stored position of arms 30, 32, it can be seen that the free extremities of arms 30, 32 that hold support ring 36 of collecting unit 34 are located spacedly away from the animal's anus. Thus, the dog may sit on the ground without being hindered by feces collecting device 10, and without sitting in his own feces like in prior art devices wherein no pivotable collecting unit support arms 30, 32 are provided.

It is noted that although no receptacle 38 is installed in support ring 36 when arms 30, 32 are pivoted into their stored position, it is envisioned in alternate embodiments to have feces receptacles that would not hinder the attachment of arms 30, 32 to harness 12.

It is indicated in the present specification that the receptacle rim 40 is at least semi-rigid. This means that it may be semi-rigid or rigid. In the case of a rigid rim 40, it could not be folded to close receptacle 38 on itself and over the feces, so a semi-rigid rim 40 is advantageous. The at least semi-rigidity or rim 40 is desirable since it allows receptacle 38 to rest on support ring 36.

Generally, alternate feces collecting units can be envisioned within the scope of the present invention, supported by one or more arms that are pivotable to move the feces collecting unit away from the dog's anus once the dog is done defecating.

Also, although feces collecting device 10 is shown as being in the form of a doll, it is understood that it could have any suitable aesthetic appearance without departing from the scope of the present invention.

1. An animal feces collecting device comprising:
a harness for releasably attaching said collecting device to an animal;
at least one arm defining a proximal end pivotally attached to said harness and a distal free end opposite said proximal end;
a feces collecting unit carried by said arm at said distal end thereof; and
an attachment member carried by said harness;
wherein said arm is pivotable between an operative position in which said arm clears said harness and is disengaged from said attachment member for positioning said arm distal end and said feces collecting unit adjacent to the animal's anus, and a stored position in which said arm is pivoted back against said attachment member to attach said arm to said attachment member and for positioning said arm distal end spacedly away from the animal's anus.

2. An animal feces collecting device as defined in claim 1, further comprising a second arm defining a proximal end pivotally attached to said harness and a distal fee end opposite said proximal end and carrying said feces collecting unit in combination with said first arm.

3. An animal feces collecting device as defined in claim 2, wherein said feces collecting unit comprises a support member integrally carried by said at least one arm and by said second arm, and a feces receptacle removably engageable in said support.

4. An animal feces collecting device as defined in claim 3, wherein said support member is a support ring carried by said at least one arm and by said second arm, with said receptacle comprising an annular rim that is at least semi-rigid and that is sized and shaped to rest on said support ring, and a bag mounted to said annular rim.

5. An animal feces collecting device as defined in claim 4, wherein said annular rim can yieldingly deform to close a top mouth portion of said receptacle over said bag.

6. An animal feces collecting device as defined in claim 1, further comprising a feces container carried by said harness.

7. An animal feces collecting device as defined in claim 5, further comprising a feces container carried by said harness and sized to receive said receptacle therein.

8. An animal feces collecting device as defined in claim 2, wherein said at least one arm and said second arm are telescopic.

9. An animal feces collecting device as defined in claim 7, wherein said harness includes a doll body destined to rest on the animal's back and straps for attaching said doll body to the animal's torso, with said feces container representing the head of the doll and being attached to said doll body.

10. An animal feces collecting device as defined in claim 9, wherein said harness further comprises a pair of legs that are attached to said doll body and that hang therefrom, for extending along the flanks of the animal's torso when said harness is worn by the animal.

11. An animal feces collecting device as defined in claim 10, wherein said pair of legs have an intrinsic spring-back effect that biases them towards the animal's torso to stabilize said harness on the animal's back.
